(19) United States
(12) Patent Application Publication
(10) Pub. No.: US 2021/0271591 A1
(43) Pub. Date: Sep. 2, 2021

(54) MOCK DATA GENERATOR USING GENERATIVE ADVERSARIAL NETWORKS

(71) Applicant: AT&T Intellectual Property I, L.P., Atlanta, GA (US)

(72) Inventors: William R. Trost, Mequon, WI (US); Daniel Solero, Rockwall, TX (US); Darrell Widhalm, Columbia, MO (US)

(21) Appl. No.: 16/803,609

(22) Filed: Feb. 27, 2020

(51) Int. Cl. G06F 11/36; G06N 3/04; G06N 3/08; G06F 7/58; G06F 17/18

(52) U.S. Cl. CPC G06F 11/3684; G06N 3/0454; G06N 3/088; G06F 17/18; G06N 3/084; G06F 7/58; G06N 3/0445

(57) ABSTRACT

Mock test data is generated by providing a random input to a generator model. The random input is transformed into generated data that is then provided to a discriminator model along with production data. The discriminator model classifies the generated data and the production data as either fake or real. The discriminator model is trained by updating weights through backpropagation. Similarly, the generator model is trained to provide adjusted generated data. When the discriminator model is unable to distinguish between the classified real data and the adjusted generated data, the generator model is used to generate mock data for an application being tested.

### TECHNICAL FIELD

The present disclosure relates to application testing using mock data to populate the application. More particularly, the disclosure relates to a method, system, and computer program for generating mock data using generative adversarial networks.

### BACKGROUND

With increasingly sophisticated software applications there is a need for large volumes of realistic test data that can accurately represent existing production data. Test data generation is an essential part of software testing. It is a process in which a set of data is created to test the competence of new and revised software applications. Test data can be the actual data that has been taken from the previous operations or artificial data explicitly tailored for the application. However, accurately creating test data can be difficult. Where test data can be accurately created, it is typically costly to generate and maintain.

Often times test data is generated based on the biasness of the developer/tester. Nuisances in the data, perhaps edge cases, are overlooked as well as the proper “mix” of test data representing the data consumed by some application. Moreover, often times real production data is used in the testing cycle, in which testing systems may not be appropriately protected. This is problematic if the data is of a very sensitive nature, e.g. personally identifiable information or protected health information.

There are a number of methods for generating data for testing an application. One method is to manually create the data. However, that approach requires significant manual labor and may thus be inefficient and infeasible for obtaining large data sets. Furthermore, artificial or mock data may not be realistic, or may be inconsistent or meaningless, or at least may have distributions or other properties which are significantly different than those of real production data based on real scenarios and population.

There is a need to generate artificial or mock test data that more accurately simulates production data for the purpose of substantially improving application testing and eliminating the need to use production data for testing purposes.

### SUMMARY

One general aspect includes a method for generating mock test data for an application. The method includes providing a random input to a generator model. The random input is transformed into generated data that is then provided to a discriminator model along with production data. The production data and generated data is classified as real or fake by the discriminator model. The discriminator model is trained by updating weights through backpropagation. Similarly, the generator model is trained to provide adjusted generated data. When the discriminator model is unable to distinguish between the classified real data and the adjusted generated data, the generator model is used to generate mock data for an application being tested.

Implementations may include one or more of the following features. Random data input is provided to the generator to generate the generated data. In another implementation, random data is data is created using a normal distribution, Monte Carlo Methods or a random number generator. Another implementation may include a method where the generator model and the discriminator model include a neural network, or the method where the generator model and the discriminator model include a recurrent neural network.

One general aspect includes a system for generating mock test data for an application including a memory for storing computer instructions and a processor. The processor, coupled to the memory is responsive to executing the computer instructions and perform operations including providing a random input to a generator model and transforming the random input into generated data. The operations also include providing the generated data and production data to a discriminator model. The production data and the generated data is classified as either real data or fake data. The operations also include training the discriminator model by updating weights through backpropagation and training the generator model to provide adjusted generated data. When the discriminator model is unable to distinguish between the classified real data and the adjusted generated data, the generator model is used to generate the adjusted generated data for an application to be tested.

One general aspect includes a non-transitory computer-readable medium having computer-executable instructions stored thereon which, when executed by a computer, cause the computer to perform a method for generating mock data. The method performed includes providing a random input to a generator model and transforming the random input into generated data. The method performed includes providing the generated data and production data to a discriminator model and classifying the production data and the generated data as real data or fake data. The method performed by the computer also includes training the discriminator model by updating weights through backpropagation and training the generator model to provide adjusted generated data. The adjusted generated data is provided to the discriminator model. When the discriminator model is unable to distinguish between the real data and fake data the generator model is used to generate the adjusted generated data for an application.

### BRIEF DESCRIPTION OF THE DRAWINGS

FIG. 1 is a block diagram of a mock data generation system using generative adversarial networks.

FIG. 2 is a flowchart of a method of generating mock data using generative adversarial networks.

FIG. 3 depicts an exemplary diagrammatic representation of a machine in the form of a computer system.

### DETAILED DESCRIPTION OF ILLUSTRATIVE EMBODIMENTS

Glossary.

“Back Error propagation” involves presenting a pre-defined input vector to a neural network and allowing that pattern to be propagated forward through the network in order to produce a corresponding output vector at the output neurons. The error associated with the output vector is determined and then back propagated through the network to apportion this error to individual neurons in the network. Thereafter, the weights and bias for each neuron are adjusted in a direction and by an amount that minimizes the total network error for this input pattern. Once all the network weights have been adjusted for one training pattern, the next training pattern is presented to the network and the error determination and weight adjusting process iteratively repeats, and so on for each successive training pattern. Typically, once the total network error for each of these patterns reaches a pre-defined limit, these iterations stop and training halts. At this point, all the network weight and bias values are fixed at their then current values. Thereafter, character recognition on unknown input data can occur at a relatively high speed.

“Classification Model” is a model that attempts to draw some conclusion from observed values. Given one or more inputs a classification model will try to predict the value of one or more outcomes. Outcomes are labels that can be applied to a dataset. For example, when filtering emails “spam” or “not spam”, when looking at transaction data, “fraudulent”, or “authorized”, when looking at test data, “real” or “fake.”

“Convolution” is a mathematical operation on two functions (f and g) that produces a third function expressing how the shape of one is modified by the other. The term convolution refers to both the result function and to the process of computing it. It is defined as the integral of the product of the two functions after one is reversed and shifted.

“Convolutional Neural Networks” is a class of deep neural networks that employ a mathematical operation called convolution. Convolution is a specialized kind of linear operation. Convolutional networks are simply neural networks that use convolution in place of general matrix multiplication in at least one of their layers

“Discriminator” is a model that takes an example from the domain as input (real or generated) and predicts a binary class label of real or fake.

“Feature” is an input variable used in making predictions.

“Prediction” is a model's output when provided with an input row of a data set.

“Feedforward neural network” is an artificial neural network wherein connections between the nodes do not form a cycle. As such, it is different from recurrent neural networks. The feedforward neural network was the first and simplest type of artificial neural network devised.

“Gaussian distribution” (also normal distribution) is a type of continuous probability distribution for a real-valued random variable. It is a bell-shaped curve, and it is assumed that during any measurement values will follow a normal distribution with an equal number of measurements above and below the mean value.

“Generative Adversarial Networks” (GANs) are a deep-learning-based generative model. More generally, GANs are a model architecture for training a generative model, and it is most common to use deep learning models in this architecture. GANs train a generative model by framing the problem as a supervised learning problem with two sub-models: a generator model that is trained to generate new examples, and a discriminator model that classifies data as either real (from the domain) or fake (generated). The two models are trained together in a zero-sum game, adversarial, until the discriminator model is fooled about half the time, meaning the generator model is generating plausible examples.

“Generative modeling” is an unsupervised learning task in machine learning that involves automatically discovering and learning the regularities or patterns in input data in such a way that the model can be used to generate or output new examples that plausibly could have been drawn from the original dataset.

“Generator” is a model that takes a fixed-length random vector as input and generates a sample in the domain.

“Long Short Term Memory Recurrent Neural Network” (LSTM-RNN) is an artificial recurrent neural network (RNN) architecture used in the field of deep learning. Unlike standard feedforward neural networks, LSTM has feedback connections. It can not only process single data points (such as images), but also entire sequences of data. A common LSTM unit is composed of a cell, an input gate, an output gate and a forget gate. The cell remembers values over arbitrary time intervals and the three gates regulate the flow of information into and out of the cell.

“Loss” is a measure of how far a model's predictions are from its label (i.e. a measure of how bad the model is). To determine this value, a model must define a loss function. For example, linear regression models typically use mean squared error for a loss function, while logistic regression models use Log Loss.

“Monte Carlo methods” a broad class of computational algorithms that rely on repeated random sampling to obtain numerical results. The underlying concept is to use randomness to solve problems that might be deterministic in principle. They are often used in physical and mathematical problems and are most useful when it is difficult or impossible to use other approaches. Monte Carlo methods are mainly used in three problem classes: optimization, numerical integration, and generating draws from a probability distribution.

“Natural Language Processing” (NLP) is the sub-field of AI that is focused on enabling computers to understand and process human languages.

“Neural Networks” are a set of algorithms, modeled loosely after the human brain, that are designed to recognize patterns. They interpret sensory data through a kind of machine perception, labeling or clustering raw input. A neural network (NN), in the case of artificial neurons called artificial neural network (ANN) or simulated neural network (SNN), is an interconnected group of natural or artificial neurons that uses a mathematical or computational model for information processing based on a connectionistic approach to computation. In most cases an ANN is an adaptive system that changes its structure based on external or internal information that flows through the network. In more practical terms neural networks are non-linear statistical data modeling or decision-making tools. They can be used to model complex relationships between inputs and outputs or to find patterns in data.

“Normal Distribution” (see Gaussian Distribution).

Perceptron is an algorithm for supervised learning of binary classifiers. A binary classifier is a function which can decide whether or not an input, represented by a vector of numbers, belongs to some specific class. It is a type of linear classifier, i.e. a classification algorithm that makes its predictions based on a linear predictor function combining a set of weights with the feature vector.

“Random Number generator” is a device that generates a sequence of numbers or symbols that cannot be reasonably predicted better than by a random chance. Random number generators can be true hardware random-number generators (HRNG), which generate genuinely random numbers, or pseudo-random number generators (PRNG), which generate numbers that look random, but are actually deterministic, and can be reproduced if the state of the PRNG is known.

“Recurrent Neural Network” is a class of artificial neural networks where connections between nodes form a directed graph along a temporal sequence. This allows it to exhibit temporal dynamic behavior. RNNs can use their internal state (memory) to process sequences of inputs unlike feedforward neural networks.

“Variational autoencoder” is an architecture composed of an encoder and a decoder and trained to minimize the reconstruction error between the encoded-decoded data and the initial data. However, instead of encoding an input as a single point, it is encoded as a distribution over the latent space. The model is then trained as follows: first, the input is encoded as distribution over the latent space; second, a point from the latent space is sampled from that distribution; third, the sampled point is decoded and the reconstruction error can be computed; and finally, the reconstruction error is backpropagated through the network.

“Weight” is a coefficient for a feature in a linear model, or an edge in a deep network. The goal of training a linear model is to determine the ideal weight for each feature. If a weight is 0, then its corresponding feature does not contribute to the model.

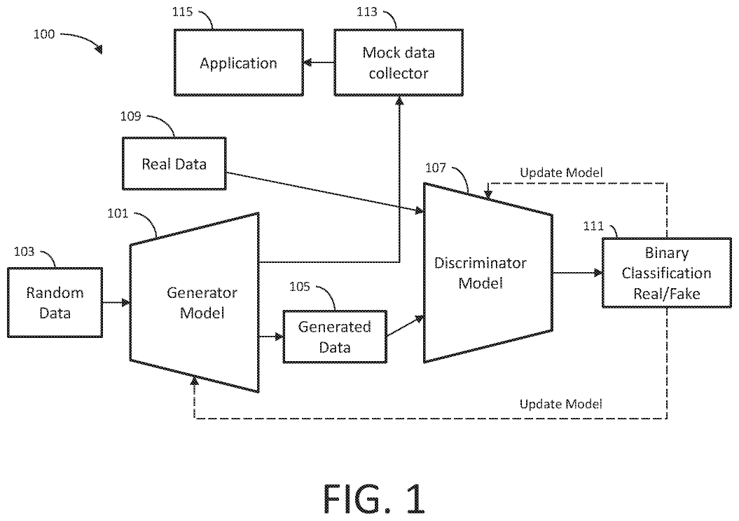

Illustrated in FIG. 1 is a mock data generation system 100. The mock data generation system 100 includes a generator model (a neural network) 101. The generator model 101 takes random data 103 such as a fixed-length random vectors as input and generates sample data. The vector may be drawn randomly from a Gaussian distribution and may be used to seed the process of generating generated data 105. After training, the generator model 101 will generate generated data 105 that correspond to points in the problem domain. The generator model 101 is built depending on the format of the test data to be generated and the data partitioning used to train a discriminator model 107. Moreover, when there is a dependency between data fields, e.g. Name, State and Driver's License then these fields are modeled together. If there is no dependency, then the particular data field can be modeled as a separate GAN or as a non-fully connected neural network with the generator model 101. This may be considered semantics since these would simply be independent neural networks within the generator. Data that is inputted into the generator model 101 is generated based on the format of the mock test data. One way to generate this input data may be through Monte Carlo methods, via a Gaussian distribution, a random number generator or any other “noise” generator. After training, the generator model 101 is kept and used to generate new mock data.

The mock data generation system 100 may also include a discriminator model 107. The discriminator model (a neural network) 105 receives real data 109 and/or generated data 105 and predicts a binary classification 111 of “real” or “fake”. The generated data 105 are the output of the generator model 101. The discriminator 107 is a normal (and well understood) classification model. The discriminator model 107 is initially trained with live production data (real data 109) in an appropriate environment depending on the sensitivity of the data. It is assumed that this data can be partitioned into data fields not necessarily of the same length. There is no restriction on the type of data, e.g., language, binary, images, etc.; however, this will require a neural network capable of “learning” the data format. One such data format example is <Name>, <State>, <Driver's License>, <Social Security>. Moreover, for the purposes of training the discriminator model 107, the data is required to be labeled as “real” or “fake”. This implies that the discriminator should be trained with both positive and negative, e.g., real/fake, data. The more data the better.

The concept is to use regular expressions in order to generate mock test data. As regular expressions can be realized by a “generalized non-deterministic finite automaton”, which in itself is a simplistic Turing machine, it is a natural extension to consider the use of deep learning for this solution. Generative Adversarial Networks (GANs) may be used for an automated system to learn from test data and generate production like mock test data used for the purposes of application testing. The generator model 101 generate new data instances while the discriminator model 107 evaluates them for authenticity.

A GAN can be considered as a Zero-Sum Game, between a counterfeiter (Generator) and a cop (Discriminator). The counterfeiter is learning to create fake money, and the cop is learning to detect the fake money. Both of them are learning and improving. The counterfeiter is constantly learning to create better fakes, and the cop is constantly getting better at detecting them. The end result being that the counterfeiter (Generator) is now trained to create ultra-realistic money.

GANs have been used mainly for generating photo realistic pictures for the entertainment industry. As such, they are realized by Convolutional Neural Networks (CNN) which are known for analyzing photographic imagery.

As test data is generally textual in nature, a CNN is generally not a good fit in this application. However, there are many different types of neural networks that are potential candidates for this purpose. As such, without defining all the possible implementations for the purpose of patentability, as new types of neural networks are likely to still be invented, a number of examples are provided herein. For example, a Recurrent Neural Network (RNN) or a Long Short Term Memory Recurrent Neural Network (LSTM-RNN), if there is a time dependency nature to the test date, are choices perhaps as an Encoder (generator model 101)/Decoder (discriminator model 107). Moreover, if there is a semantic meaning to the test data, Natural Language Processing (NLP) would work as well. The point is, the type of data will determine the appropriate deep learning model. This will provide for a very wide range for generation test data. Regardless of the type or types of neural networks chosen for the generator model 101 and discriminator model 107, the GAN model is appropriate for this solution.

In operation, the discriminator model 107 is trained with real data 109 and generated data 105 from the generator model 101. The weights of the generator model 101 remain constant while the generator 101 produces data for the training of the discriminator model 107. The discriminator model 107 connects to two loss functions. During training of the discriminator model 107, the discriminator model 107 ignores the generator model 101 loss and just uses the discriminator model 101 loss. The generator model 107 loss is used during generator model 101 training, as described herein. During discriminator model 107 training:
The discriminator model 107 classifies both real data and fake data from the generator model 101.
The discriminator model 107 loss penalizes the discriminator model 107 for misclassifying a real instance as fake or a fake instance as real.
The discriminator model 107 updates its weights through backpropagation from the discriminator model 107 loss through the discriminator network.

To train a neural net (such as generator model 101) the net's weights may be altered to reduce the error or loss of its output. In the mock data generation system 100 the generator model 101 feeds into the discriminator model 107, and the discriminator model 107 produces the output that is to be affected. The loss of the generator model 101 penalizes the generator model 101 for producing a sample that the discriminator network classifies as fake. Backpropagation adjusts each weight in the right direction by calculating how the output would change if the weight is changed. The effect of a generator weight depends on the effect of the discriminator weights it feeds into. So, backpropagation starts at the output and flows back through the discriminator model 107 into the generator model 101.

The generator model 101 learns to create fake data by incorporating feedback from the discriminator model 107. The generator model 101 learns to make the discriminator model 107 classify the output of the generator model 101 as real. Training of the generator model 101 requires tighter integration between the generator model 101 and the discriminator model 107 than required by the training of the discriminator model.

The generator model is trained with the following procedure:
Sample random noise.
Produce generator output from sampled random noise.
Get discriminator “Real” or “Fake” classification for generator output.
Calculate loss from discriminator classification.
Backpropagate through both the discriminator and generator to obtain gradients.
Use gradients to change only the generator weights.

As the generator model 101 improves with training, the discriminator model 107 performance gets worse because the discriminator cannot easily differentiate between real and fake data. If the generator succeeds perfectly, then the discriminator has a 50% accuracy. In effect, the discriminator flips a coin to make its prediction.

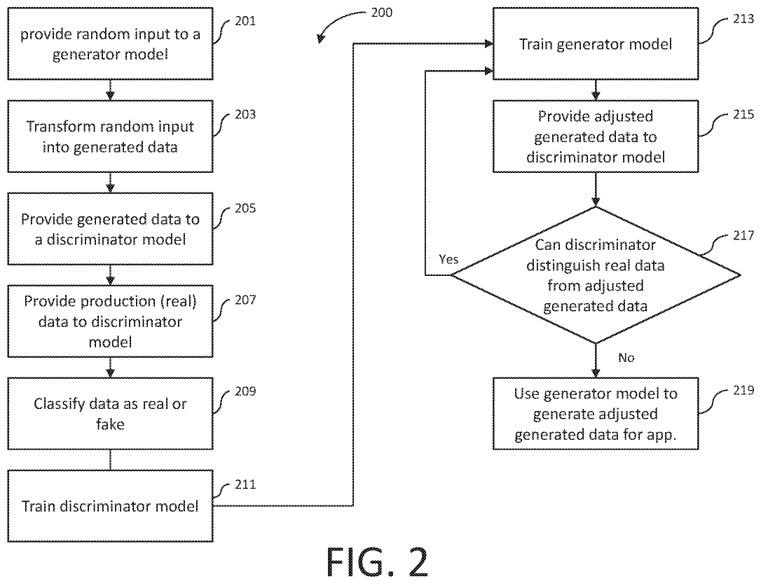

Illustrated in FIG. 2 is a flowchart for a method for generating mock test data.

In step 201, the method provides random input to a generator model.

In step 203, the generator model transforms the random input into generated data (mock data).

In step 205, the method 200 provides the generated data to a discriminator model.

In step 207, the method 200 provides production data to the discriminator model.

In step 209, the method 200 determines if the mock test data is real or fake and classifies the data as real or fake.

In step 211, the method 200 trains the discriminator model. If data is classified as fake, standard back error propagation is used to correct for errors, and new generated data is provided to the discriminator model.

In step 213, the method 200 trains the generator model.

In step 215, the method 200 provides adjusted generated data to the discriminator model.

In step 217, the method 200 determines whether the discriminator can distinguish between real data and the adjusted generated data. If it can, the process continues until the discriminator model 101 is unable to tell the difference between test data generated by the generator model 101 and the test data (real data 109) used to train the discriminator model 107. At this point the generator model is now generating mock test data indiscernible from real data 109. In step 219, the method 200 provides the generator to a test environment where it can be used to generate mock test data for the given application to be tested.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a non-transitory computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” is used herein to mean serving as an instance or illustration. Any embodiment or design described herein as an “example” is not necessarily to be construed as preferred or advantageous over other embodiments or designs. Rather, use of the word example is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

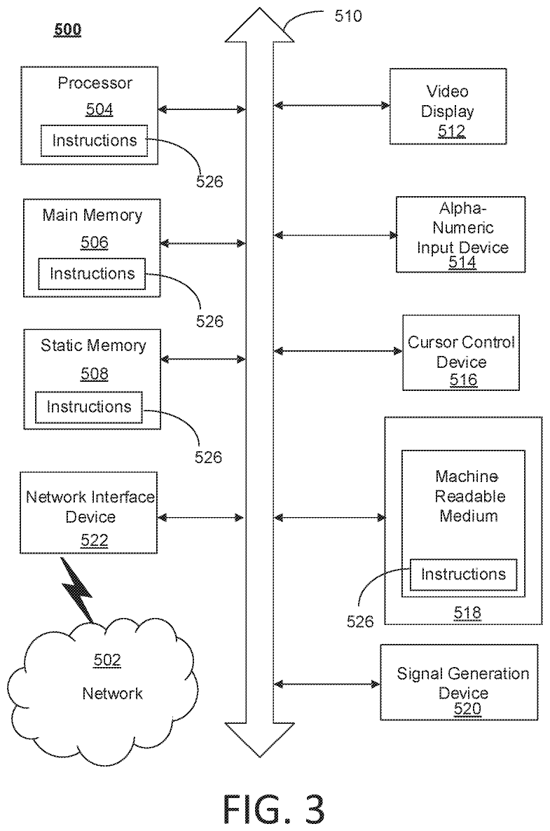

FIG. 3 depicts an exemplary diagrammatic representation of a machine in the form of a computer system 500 within which a set of instructions, when executed, may cause the machine to perform any one or more of the methods described above. One or more instances of the machine can operate, for example, as a processor or system 100 of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed:

1. A method for generating mock test data for an application comprising:
providing a random input to a generator model;
transforming the random input into generated data;
providing the generated data to a discriminator model;
providing production data to the discriminator model;
producing classifications for the production data and the generated data by classifying the production data and the generated data as classified real data or classified fake data;
training the discriminator model by updating weights through backpropagation;
training the generator model to provide adjusted generated data;
providing the adjusted generated data to the discriminator model;
when the discriminator model is unable to distinguish between the classified real data and the adjusted generated data using the generator model to generate the adjusted generated data for the application.

2. The method of claim 1, wherein generating the generated data comprises inputting random data to the generator.

3. The method of claim 2, wherein the random data is data is created using a normal distribution.

4. The method of claim 2, wherein the random data is created using Monte Carlo Methods.

5. The method of claim 2, wherein the random data is created using a random number generator.

6. The method of claim 1, wherein the generator model and the discriminator model comprise a neural network.

7. The method of claim 1, wherein the generator model and the discriminator model comprise a recurrent neural network.

8. A system for generating mock test data for an application comprising:
a memory for storing computer instructions;
a processor coupled with the memory, wherein the processor, responsive to executing the computer instructions, performs operations comprising:
providing a random input to a generator model;
transforming the random input into generated data;
providing the generated data to a discriminator model;
providing production data to the discriminator model;
producing classifications for the production data and the generated data by classifying the production data and the generated data as classified real data or classified fake data;
training the discriminator model by updating weights through backpropagation;
training the generator model to provide adjusted generated data;
providing the adjusted generated data to the discriminator model;
when the discriminator model is unable to distinguish between the classified real data and the adjusted generated data using the generator model to generate the adjusted generated data for the application.

9. The system of claim 8, wherein generating the generated data comprises inputting random data to the generator.

10. The system of claim 9, wherein the random data is data is created using a normal distribution.

11. The system of claim 9, wherein the random data is created using Monte Carlo Methods.

12. The system of claim 9, wherein the random data is created using a random number generator.

13. The system of claim 8, wherein the generator model and the discriminator model comprise a neural network.

14. The system of claim 8, wherein the generator model and the discriminator model comprise a recurrent neural network.

15. A non-transitory computer-readable medium having computer-executable instructions stored thereon which, when executed by a computer, cause the computer to perform a method comprising:
providing a random input to a generator model;
transforming the random input into generated data;
providing the generated data to a discriminator model;
providing production data to the discriminator model;
producing classifications for the production data and the generated data by classifying the production data and the generated data as classified real data or classified fake data;
training the discriminator model by updating weights through backpropagation;
training the generator model to provide adjusted generated data;
providing the adjusted generated data to the discriminator model;
when the discriminator model is unable to distinguish between the classified real data and the adjusted generated data using the generator model to generate the adjusted generated data for an application.

16. The non-transitory computer-readable medium of claim 15, wherein generating the generated data comprises inputting random data to the generator.

17. The non-transitory computer-readable medium of claim 16, wherein the random data is data is created using a normal distribution.

18. The non-transitory computer-readable medium of claim 16, wherein the random data is created using Monte Carlo Methods.

19. The non-transitory computer-readable medium of claim 16, wherein the random data is created using a random number generator.

20. The non-transitory computer-readable medium of claim 15, wherein the generator model and the discriminator model comprise a neural network.
